(19) United States
(12) Patent Application Publication
(10) Pub. No.: US 2011/0010711 A1
(43) Pub. Date: Jan. 13, 2011

(54) Reliable movement of virtual machines between widely separated computers

(76) Inventor: Niket Keshav Patwardhan, San Jose, CA (US)

Correspondence Address: Niket Patwardhan, P.O. Box 675, Santa Clara, CA, 95052, US

(21) Appl. No.: 12/803,970

(22) Filed: Jul. 12, 2010

Related U.S. Application Data
(60) Provisional application No. 61/270,596, filed on Jul. 10, 2009.

(51) Int. Cl. G06F 9/455

(52) U.S. Cl. 718/1

(57) ABSTRACT

This invention describes an improved method of transferring running VMs between servers that would allow them to move between datacenters, even ones that are halfway across the world from each other.

### PRIORITY CLAIM

This application claims the priority date set by U.S. Provisional Patent Application 61/270,596 titled “Moving Virtual Machines between DataCenters” filed on Jul. 10, 2009.

### RELATED APPLICATIONS

U.S. Provisional Patent Application 61/211,841

### STATEMENT REGARDING FEDERALLY SPONSORED RESEARCH OR DEVELOPMENT

Not Applicable

### SMALL ENTITY STATUS

The applicant claims small entity status.

### BACKGROUND OF THE INVENTION

Today with the need to service millions of users accessing a company's websites, many companies centralize their servers into large server farms located at widely separated datacenters. For many reasons, there is a need to maintain separate data centers and to move the data and processing between these data centers, often without disrupting the operation of applications using the data and processors.

With the advent of virtualized machines (VMs), not only does the data or application move, the entire machine running the application may also move. This presents particularly interesting challenges, but also provides a structure that simplifies many aspects. A basic problem with moving a virtual machine and its associated disk is the sheer size of the total storage that needs to be moved.

Current methods (as described in the proof of concept proposal by VMWare and CISCO) move the virtual machine first, maintaining the connection to its disks in the initial datacenter. After the move of the execution of the VM, blocks are retrieved from the initial datacenter over the network, creating a need for low latency connections between the datacenters, which is physically difficult for widely separated datacenters, and which creates unusual demands on the network service.

In U.S. Pat. No. patent 6,795,966 a differential checkpointing scheme is used to record successive checkpoints of a running VM and these checkpoints are moved over and installed on the target machine. The primary difficulty with moving the storage first has been that a VM may “dirty” pages and blocks faster than they can be moved. Today's implementations run a computation that projects whether the data transfer will terminate or converge to a small set of dirty blocks given the existing network conditions, and forces abandonment of the move if this cannot be met. “Small” is defined by the time it would take to move the remaining blocks, this must be shorter than the maximum dead time, since these blocks are likely to be essential to the operation of the VM; and if they are not transferred within the maximum dead time, network connections could break, or other application time limits may not be met. This is extremely frustrating from a datacenter operator's point of view, as a scheduled maintenance could be postponed indefinitely by the existence of some badly behaved VMs or applications.

The references are primarily U.S. patents assigned to VMWare Inc, which has been marketing the ability to move VMs between servers, as long as they are within the same datacenter. Despite the references, they consider movement between datacenters a hard problem, that will require 2-3 years to solve, as can be seen from their proof of concept announcement in the referenced web pages.

### REFERENCES

U.S. Pat. No. 6,795,966—Lim, et al—“Mechanism for restoring, porting, replicating and checkpointing computer systems using state extraction”

U.S. Pat. No. 7,447,854—Cannon—“Tracking and replicating changes to a virtual disk”

U.S. Pat. No. 7,529,897—Waldspurger, et al—“Generating and using checkpoints in a virtual computer system”

US Patent Application 20080270674—Matt Ginzton—“Adjusting Available Persistent Storage During Execution in a Virtual Computer System”

US Patent Application 20090037680—Osten Kit Colbert et at—“ONLINE VIRTUAL MACHINE DISK MIGRATION”

US Patent Application 20090038008—Geoffrey Pike—“Malicious Code Detection”

US Patent Application 20090044274—Dmitri Budko—“Impeding Progress of Malicious Guest Software”

Web Page—http://blogs.vmware.com/networking/2009/06/vmotion-between-data-centersa-vmware-and-cisco-proof-of-concept.html

Web Page—http://searchdisasterrecovery.techtarget.com/news/article/0,289142,sid190_gci1360667,00.html

### SUMMARY OF THE INVENTION

This invention is an improvement to the current methods of transferring Virtual Machines (VMs)—allowing standard high bandwidth networks to be used for accomplishing the move. Latency requirements are significantly relaxed and the completion of the move is guaranteed as long as the network stays up. Rather than computing whether the network can transfer blocks sufficiently faster than the “dirty rate” to keep reducing the number of dirty blocks, in this invention we slow down the “dirty rate” so it is always lower than the network transfer rate once the goal of moving the VM has been declared.

### DESCRIPTION OF THE DRAWINGS

No drawing

### DETAILED DESCRIPTION OF THE INVENTION

Every modern computer system has a page table that maps the virtual addresses of processes running on the computer to physical pages. A VM hypervisor takes control of these page tables to create the areas where a particular VM may run. This table can be set so that pages are marked read only, and VM hypervisors use this feature to implement copy-on-write (COW) schemes that allow VMs derived from a master VM to share pages until they are actually changed. In this invention this same feature is used once the goal of moving a VM from one computer to another has been declared.

First, all the pages of a VM are added to a “dirty” list. The transfer of the memory to the other computer is then commenced, and the VM is allowed to run. As the transfer process picks up pages to transfer them to the destination system it marks them read-only, and removes them from the “dirty” list. Current methods create a “checkpoint” by marking all the pages read-only, then transferring the checkpointed pages to the destination computer.

When the VM does a write to a read-only page the method of this invention would respond very differently than existing methods. Instead of allocating new pages and allowing writes to these new pages, the method of this invention would return the page to the process writeable, and re-record the page in the “dirty” list. The VM is allowed to write to the page and resume execution after a delay. The delay used is the amount of time it would take to transfer the page to the new system at the available network bandwidth, or slightly larger. Note that this is not the total time it would actually take the page to get there, only the transfer time is used. Using this strategy automatically forces the VM to reduce its dirty rate below the network transfer rate. Meanwhile the transfer process is transferring the state of the VM, and when it reaches a page that has been marked writeable, it resets it to read-only before initiating the transfer, and takes it out of the dirty list after the transfer. Writes to this page are blocked until the page has been transferred and removed from the dirty list, and will place it back on the dirty list when they happen. When the transfer process has transferred all the pages of the VM, it starts over with the remaining blocks in the “dirty” list. Because the above technique of returning pages to the VM when it wants to write to them constrains it to fill this list slower than the transfer process can empty it, this list is guaranteed to become empty or fall below some threshold at some point, at which time the remaining pages and execution of the VM can be transferred to the new machine.

This method is far superior to the method where the execution is transferred first and then needed pages are paged in with high priority over the network. First of all, it avoids any need for any priority scheme or immediate acknowledgement on the transfer of the pages, allowing a single simple high speed TCP connection to accomplish the transfer. Secondly, the VM only has to wait for a small fraction higher than the transfer time of each page. On a 10 G connection the wait time for a 4K page will be 4 to 8 microseconds instead of the 200 mS or more roundtrip time that would be needed to fetch a remote page when the two datacenters are on opposite sides of the country or world. Even with a 10M connection, the wait time of 4-8 mS would be much shorter than the delay associated with fetching a page even from a neighboring rack, which could be as much as 20 mS. Third, read accesses vastly outnumber write accesses, so since this method only slows down writes, a lot fewer pages are delayed, and the total performance hit is less. Finally, since execution is not transferred until every page has been transferred, there is no need for checkpoints, and there is no “dead” or “stun” time, or it is very small. Also, if the network or the destination system goes down before the execution is transferred, nothing is lost and execution can remain on the originating system.

It is also better than the method used by VMWare, which although it leaves execution on the intial system until all of the state has been transferred, requires the creation and transfer of whole checkpoints. If the VM can dirty pages faster than the the network can transfer them, which is typical on all but the fastest networks and especially on networks with large latencies such as those where the intial and destination computers are separated by large distances, then the transfer process can never successfuly complete without a large “dead” or “stun” time. This method is guaranteed to complete if the network between the initial and destination computers stays up. The “dead” or “stun” time is limited to the time it takes to transfer the last few pages and switch over IO and communication links, which can be microseconds instead of the tens of seconds or more needed to transfer a checkpoint.

The same techniques can be applied to disk blocks as well.

Standard methods of encrypting the data transfer such as using SSL on the TCP connection will serve to protect the privacy of the transfer, and any stream compression method can be used. Existing methods of preparing the VM for the transfer (such as ballooning to help the compression) are still applicable.

1. A method implemented by a set of computers whereby a virtual machine running on one computer may be reliably moved to another computer without noticeable pause in execution, where the following steps are carried out in the specified order:
i) all pages of the virtual machine to be transferred are listed in a “dirty” list and the virtual machine is allowed to run;
ii) the transfer of the data of the pages listed in the “dirty list” to the destination computer is started, and runs in parallel with steps iii) and iv); when transfer of a page starts, it is marked read-only and removed from the dirty list;
iii) when the executing virtual machine attempts to write to a “clean” page, that page is put back on the dirty list and the read-only mark is removed;
iv) the virtual machine is forced to wait for slightly more than the time it takes to transfer the page to the destination computer before it is allowed to resume, but does not have to wait for the transfer of the page to either start or complete;
v) when the “dirty list” is empty, or when it is small enough, the virtual machine is paused, the remaining pages (if any) in the “dirty list” are transferred, network connections and IO are switched over using existing prior art techniques, and then the virtual machine machine is allowed to resume execution on the destination computer.
